(19) United States
(12) Patent Application Publication
(10) Pub. No.: US 2014/0111701 A1
(43) Pub. Date: Apr. 24, 2014

(54) Audio Data Spread Spectrum Embedding and Detection

(71) Applicant: Dolby Laboratories Licensing Corporation, San Francisco, CA (US)

(72) Inventor: Regunathan Radhakrishnan, Foster City, CA (US)

(73) Assignee: DOLBY LABORATORIES LICENSING CORPORATION, San Francisco, CA (US)

(21) Appl. No.: 14/054,438

(22) Filed: Oct. 15, 2013

Related U.S. Application Data
(60) Provisional application No. 61/717,497, filed on Oct. 23, 2012.

(51) Int. Cl. G10L 19/018; H04N 5/60; H04N 21/439

(52) U.S. Cl. CPC G10L 19/018; H04N 21/4394; H04N 5/602
USPC 348/738; 725/151; 700/94

(57) ABSTRACT

An audio data spread spectrum embedding and detection method is presented. For each audio frame, a noise sequence is chosen according to the data to be embedded. Then, a spectrum of a chosen noise sequence is shaped by a spectrum of a current audio frame and subtracted from a current frame's spectrum. During detection, a detector is used on a watermarked audio frame to first whiten the watermarked audio frame. Detection scores are then computed against two competing Adaboost learning models. A detected bit is chosen according to the model with a maximum detection score.

### CROSS REFERENCE TO RELATIONS APPLICATIONS

This application claims the benefit of U.S. Provisional Application No. 61/717,497 filed on Oct. 23, 2012, which is hereby incorporated by reference in its entirety.

### FIELD

The present disclosure relates to audio data embedding and detection. In particular, it relates to audio data spread spectrum embedding and detection, where detection is based on Adaboost learning.

### BACKGROUND

In the watermarking process the original data is marked with ownership information (watermarking signal) hidden in the original signal. The watermarking signal can be extracted by detection mechanisms and decoded. A widely used watermarking technology is spread spectrum coding. See, e.g. D. Kirovski, H. S. Malvar, “Spread spectrum watermarking of audio signals” IEEE transactions on signal processing, special issue on data hiding (2002) incorporated herein by reference in its entirety.

### SUMMARY

According to a first aspect of the disclosure, a method to embed data in an audio signal is provided, comprising: selecting a pseudo-random sequence according to desired data to be embedded in the audio signal; shaping a frequency spectrum of the pseudo-random sequence with a frequency spectrum of the audio signal, thus forming a shaped frequency spectrum of the pseudo-random noise sequence; and subtracting the shaped frequency spectrum of the pseudo-random sequence from the frequency spectrum of the audio signal spectrum.

According to a second aspect of the disclosure, a computer-readable storage medium is provided, having stored thereon computer-executable instructions executable by a processor to detect embedded data in an audio signal, the detecting comprising: calculating detection scores from a set of competing statistical learning models, wherein the detection scores are based on the audio signal; and performing a detection decision as to which data is embedded in the audio signal by comparing with each other the calculated detection scores.

According to a third aspect of the disclosure, a system to embed data in an audio signal is provided, the system comprising: a processor configured to: select a pseudo-random sequence according to desired data to be embedded in the audio signal; shape a frequency spectrum of the pseudo-random sequence with a frequency spectrum of the audio signal, thus forming a shaped frequency spectrum of the pseudo-random sequence; and subtract the shaped frequency spectrum of the pseudo-random noise sequence from the frequency spectrum of the audio signal spectrum.

According to a fourth aspect of the disclosure, a system to detect embedded data in an audio signal is provided, the system comprising: a processor configured to: calculating detection scores from a set of competing statistical learning models, wherein the detection scores are based on the audio signal; and performing a detection decision as to which data is embedded in the audio signal by comparing a first model score for detecting a zero bit with a second model score for detecting a one bit.

The details of one or more embodiments of the disclosure are set forth in the accompanying drawings and the description below. Other features, objects, and advantages will be apparent from the description and drawings, and from the claims.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure.

FIG. 1 shows a block diagram of a computer- or processor-based spread spectrum embedding method for an input audio data in accordance with an embodiment the present disclosure.

FIG. 2 shows an example of a window function used in the embodiment of FIG. 1.

FIG. 3 shows noise sequences in a time domain and a frequency domain.

FIG. 4 shows a block diagram of a computer- or processor-based detection method in accordance with an embodiment of the disclosure.

FIG. 5 shows a result of whitening with reference to the embodiment of FIG. 4.

FIGS. 6-1 and 6-2 show probability distributions of detection statistic when embedding and when there is no data embedded.

FIGS. 7-9 show examples of arrangements employing the embedding method or system of FIG. 1 and the detecting method or system of FIG. 4.

FIG. 10 shows a computer system that may be used to implement the audio data spread spectrum embedding and detection system of the present disclosure.

### DETAILED DESCRIPTION

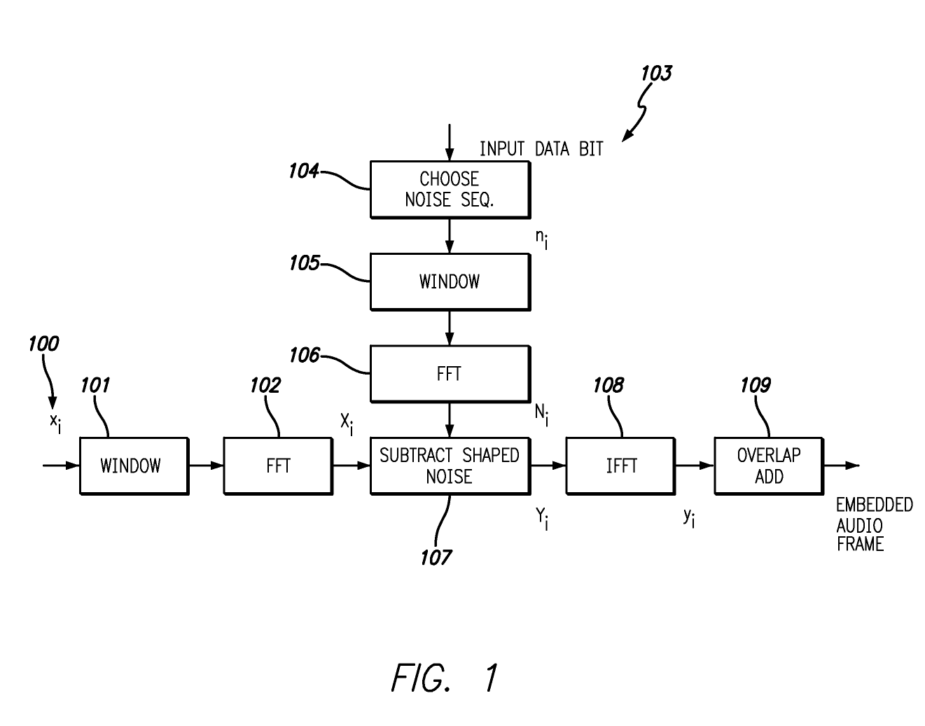

FIG. 1 shows some functional blocks for implementing spread spectrum embedding of an input audio data in accordance with an embodiment of the present disclosure. In accordance with the embodiment of FIG. 1, the data embedding method shapes a noise sequence using a spectrum of the input audio signal. The method or system of FIG. 1 is a computer- or processor-based method or system. Consequently, it will be understood that the functional blocks shown in FIG. 1 as well as in several other figures can be implemented in a computer system as is described below using FIG. 10.

The input audio signal (100) is initially divided into frames each having a length of N samples (e.g. 2048 samples). Each frame can be represented as x, while a time domain representation of frame i can be represented as xᵢ. Therefore, one skilled in the art will understand that although a frame of length 2048 samples is provided in the present embodiment, other possible frame lengths could be used as well.

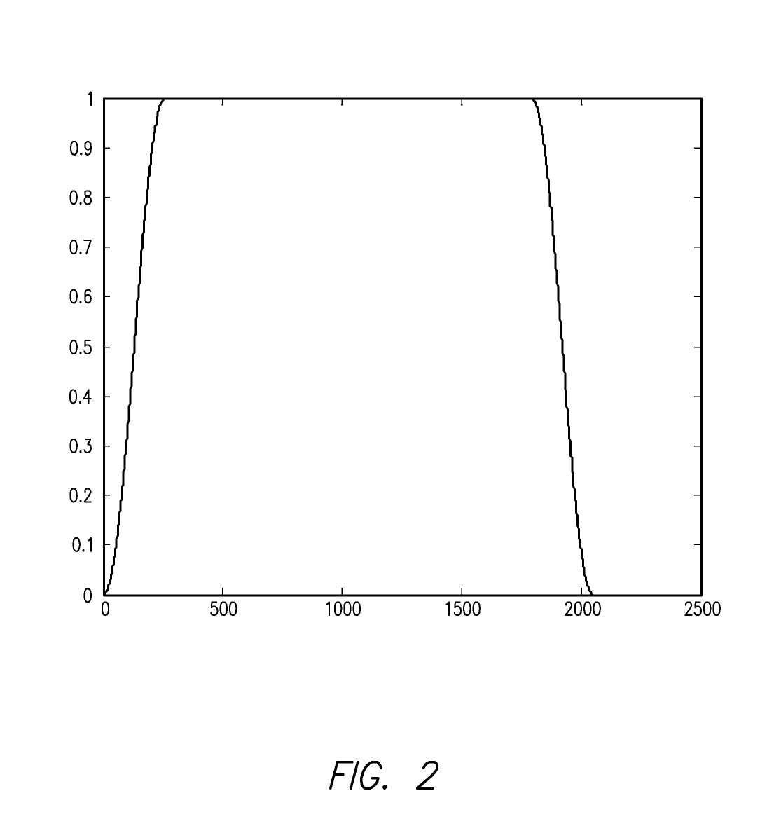

After the input audio signal (100) is divided into frames, each input audio signal frame is then multiplied by a window function (101). This window function acts as a mathematical function that is zero-valued outside of a chosen interval and retains the samples that are within the chosen interval. In one embodiment, a tukey window, as shown in FIG. 2, can be used although any window can be implemented for this step.

In a further step of the data embedding method shown in FIG. 1, a fast Fourier transform (FFT) is applied (102) to each frame to obtain a frequency domain representation Xᵢ. In alternative embodiments, other types of transforms may be used.

In accordance with the method of FIG. 1, noise sequence generation is also performed. For example, two noise sequences n₀ and n₁, are generated, each noise sequence being used to represent one bit of data (103). In other words, if sequence n₀ is used a zero bit is to be embedded in the audio frame, while sequence n₁ is used if a one bit is to be embedded in the audio frame. The noise sequences can be shaped so that only some of their values in a frequency representation are different from zero. By way of example, the frequency coefficients (or “bins”) carrying noise information of frequency representations N₀ and N₁ of n₀ and n₁ respectively, can be in a 2 to 7.5 kHz range, as human hearing is sensitive in such range. More generally, information carrying coefficients can be chosen in a 20 Hz to 20 kHz range, to ensure watermark robustness. Therefore, assuming that the frequency representation of n₀ and n₁ is N₀(k) for 1≦k≦N and N₁(k) for 1≦k≦N, respectively, where N is the number of samples of each noise sequence corresponding to the number of samples N of each frame Xᵢ (e.g., N=2048), the coefficients k are so chosen that N₀(k)=0 for 1≦k≦m and m+L+1≦k≦N, and N₁(k)=0 for 1≦k≦m and m+L+1≦k≦N while N₀(k) and N₁(k)≠0 for the L coefficients having indices in the {m+1 . . . m+L} range, such range corresponding to the selected frequency range of interest (e.g. 2 kHz to 7.5 kHz).

In accordance with an embodiment of the present disclosure, each of the L frequency coefficients of N₀(k) or N₁(k) is modified to encode a chip from a chip sequence for embedding either a zero (identified as W⁰) or a one (identified as W¹). In other words, W⁰ and W¹ represent pseudo-random chip sequences of {+1, −1} used to embed a zero or one, respectively.

More in particular, sequence N₀ can be defined as follows:

$$\begin{matrix}{N}_{0} ( k ) = 1 - g if {W}^{0} ( k - m ) \\ = 1 \\ = 1 - \frac{1}{g} if {W}^{0} ( k - m ) \\ = - 1\end{matrix}$$

Here, k represents indices of selected frequency coefficients with the range {m+1, m+2, . . . , m+L}. A g parameter relates to a gain modification within the chosen frequency range (e.g. between 2 kHz and 7.5 kHz). g can be defined by g²=10^{(Δ/10)} where Δ is expressed in dB and is usually equal to 1 dB. Furthermore, as already noted above, N₀(k)=0 for 1≦k≦m and m+L+1≦k≦N.

Similarly, N₁ can be defined as follows:

$$\begin{matrix}{N}_{1} ( k ) = 1 - g if {W}^{1} ( k - m ) \\ = 1 \\ = 1 - \frac{1}{g} if {W}^{1} ( k - m ) \\ = - 1\end{matrix}$$

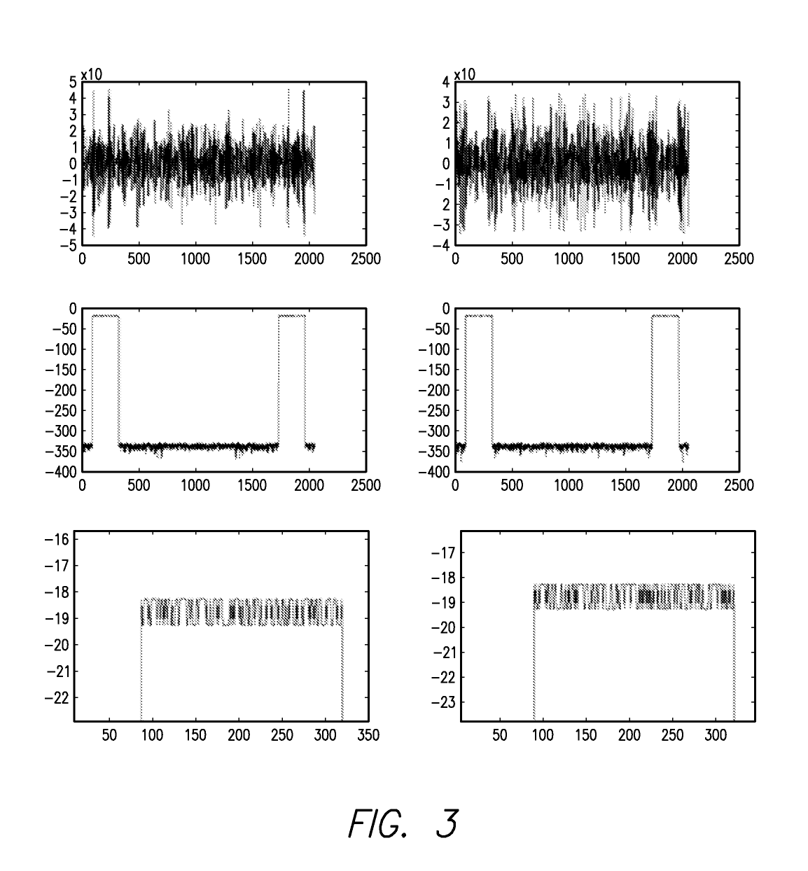

Also in this case, k represents indices of the selected frequency coefficients with the range {m+1, m+2, . . . m+L}. g is the same parameter as defined above, which is the gain modification at frequencies within the chosen frequency range. Furthermore, N₁(k)=0 for 1≦k≦m and m+L+1≦k≦N. Examples of noise sequences in a time domain and a frequency domain are shown in FIG. 3.

After N₀ and N₁ are formed, an inverse Fourier transform is performed. As a result of the inverse Fourier transformation, the time domain representation of the two noise sequences N₀ and N₁ (n₀ and n₁) are obtained. The process for generating the two noise sequences to represent input data bit 0 or input data bit 1 can be done once offline, if desired and is generally represented by box (104). Such sequences are then multiplied by a window function (105) and transformed (106) similarly to what was performed in blocks/steps (101) and (102) for the input audio signal, thus generating a noise sequence Nᵢ adapted to embed information related to a 0 input data bit or 1 input data bit into each sample within a selected frequency range of an audio frame Xᵢ.

As a consequence, in block (107) of FIG. 1, a modified frame i (identified as Yᵢ) is obtained through the combination of audio data frame Xᵢ (in the frequency domain) and noise Nᵢ containing information about a data bit dᵢ=0, 1. In particular, with reference to FIG. 1, Yᵢ can be identified as follows:

Yᵢ=Xᵢ−Xᵢ.*FFT(tukey_win.*n₀) if dᵢ=0, where FFT(tukey_win.*n₀)=N₀

Yᵢ=Xᵢ−Xᵢ.*FFT(tukey_win.*n₁) if dᵢ=0, where FFT(tukey_win.*n₁)=N₁

and where .* represents point-wise multiplication of two vectors.

In other words, the noise sequence (n₀ or n₁) at the output of block (104) is chosen according to the data bit (dᵢ) (the input (103)) to be embedded in a particular frame. Then, a chosen noise sequence undergoes a window function (105) (e.g. a tukey window) and further transformed (106) (e.g. using a fast Fourier transformation (FFT)). The end result is a transform domain representation Nᵢ of the noise sequence which is shaped in accordance with the equations above using the audio frame's spectrum Xᵢ. As shown in the above equations, the transform domain representation of the noise sequence shaped using the audio frame's spectrum is subtracted from the audio frame's spectrum. As described above, in an embodiment of the present disclosure, such subtraction only occurs in a specific frequency subrange of the audio frame.

Therefore, in accordance with the present disclosure, the noise sequence is shaped using the spectrum of the audio signal.

In an embodiment of the diagram shown in FIG. 1, a way to later improve detection accuracy at a detector could be implemented by using a repetition of a same data bit dᵢ for a number of consecutive frames (identified as repetition_actor). For example, the repetition_actor can be a value of three. In such an example, this would indicate that the data bit dᵢ is repeated three times (or a corresponding noise sequence is repeated three times). However, with the added robustness of the signal at the detector, a tradeoff can occur with the embedding bit rate (number of embedded data bits per second of audio), which would decrease as a function of the chosen repetition_actor.

In a further step of the method shown in FIG. 1, an inverse Fourier transformation (108) is performed on the frequency domain modified frame Yᵢ in order to obtain a time domain modified frame yᵢ. Additionally, time overlapping and adding of the samples are performed in block/step (109), thus obtaining a plurality of embedded/watermarked time domain audio frames. FIG. 1 also shows an optional overlap adding module (112). Since in the embodiment of FIG. 1 frame yᵢ₋₁ and frame yᵢ are both multiplied by the same window function (e.g. a tukey window), the trailing part of frame yᵢ₋₁'s window function overlaps with the starting part of the frame yᵢ's window function. Since the window function is designed in such a way that the trailing part and the starting part add up to 1.0, the overlap add procedure of block (112) provides perfect reconstruction for the overlapping section of frame yᵢ₋₁ and frame yᵢ, assuming that both frames are not modified.

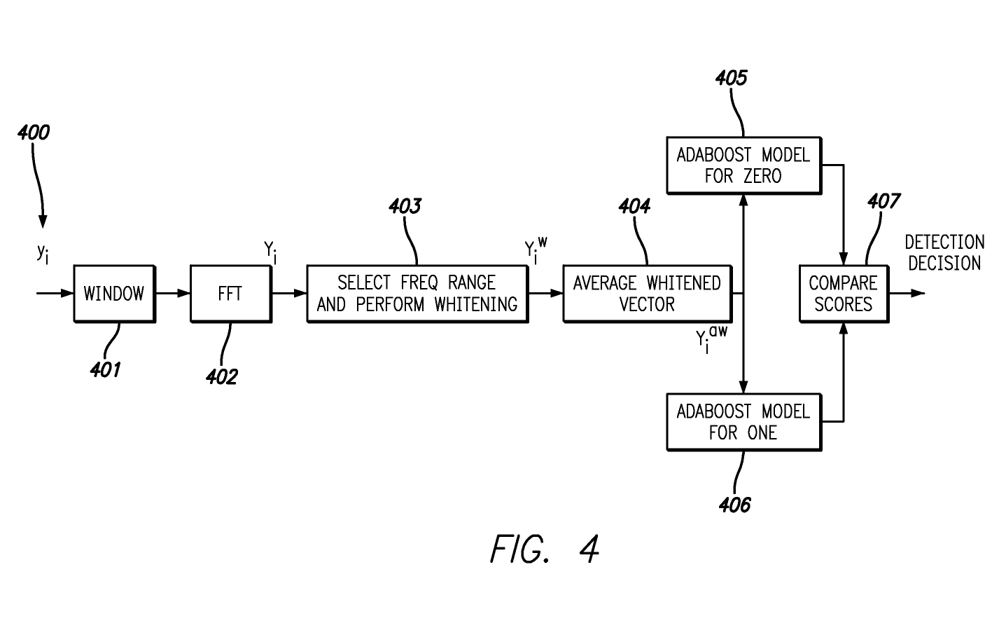

Reference will now be made to the diagram of FIG. 4, which shows a data detection operational sequence that may be implemented in hardware, software, or a combination thereof, in accordance with an embodiment of the disclosure, where a detection decision as to which data is embedded in the audio signal is performed by comparing detection scores calculated from a set of competing statistical learning models. The description of the embodiment of FIG. 4 will assume frame alignment between embedding and detection. Otherwise, a synchronization step can be used before performing the detection to ensure that alignment is satisfied. Synchronization methods are known in the art. See, for example, D. Kirovski, H. S. Malvar, “Spread-Spectrum Watermarking of Audio Signals” IEEE Transactions on Signal Processing, Vol. 51, No. 4, April 2003, incorporated herein by reference in its entirety, section IIIB of which describes a synchronization search algorithm that computes multiple correlation scores. Reference can also be made to X. He, M. Scordilis, “Efficiently Synchronized Spread-Spectrum Audio Watermarking with Improved Psychoacoustic Model” Research Letters in Signal Processing (2008), also incorporated herein by reference in its entirety, which describes synchronization by means of embedding synchronization codes, or H. Malik, A. Khokhar, R. Ansari, “Robust Audio Watermarking Using Frequency Selective Spread Spectrum Theory” Proc. ICASSP '04, Canada, May 2004, also incorporated herein by reference in its entirety, which describes synchronization by means of detecting salient points in the audio. Embedding is always done at such salient points in the audio.

As shown in FIG. 4, watermarked input audio signal frames yᵢ (400) are received at the detector. As already noted with reference to the embedding embodiment of FIG. 1, the particular frame length (e.g. 2048 samples) can be chosen based on preference. The input audio frames are then multiplied by a window function (401) and transformed (402).

In a further step of the detection method (403), frequency coefficients of the transformed signal Yᵢ are chosen within a range, in compliance with the frequency range adopted in FIG. 1. For example such range can be between 2 kHz and 7.5 kHz, corresponding to selected frequency coefficients, which can be identified as {Yᵢ^{m+1}, Yᵢ^{m+2}, . . . , Yᵢ^{m+L}}.

In order to perform detection without using the original signal Xᵢ (also called blind detection), and to reduce a noise interference of a host signal in a detection statistic, the detection method of FIG. 4 can perform a whitening step of the spectrum in the above selected frequency range. Spectral whitening can be performed, for example using cepstral filtering, where DCT is a discrete cosine transform:

Zᵢ=DCT(10*log 10(|Yᵢ|²))

After whitening is performed, the output Zᵢ has same dimensions as the selected frequency range Yᵢ but only a top number of coefficients in Zᵢ is retained, while the other coefficients of Zᵢ are zeroed out. The frequency signal obtained, keeping the top number of coefficient and zeroing out the other coefficients is identified as Zᵢ^{f}.

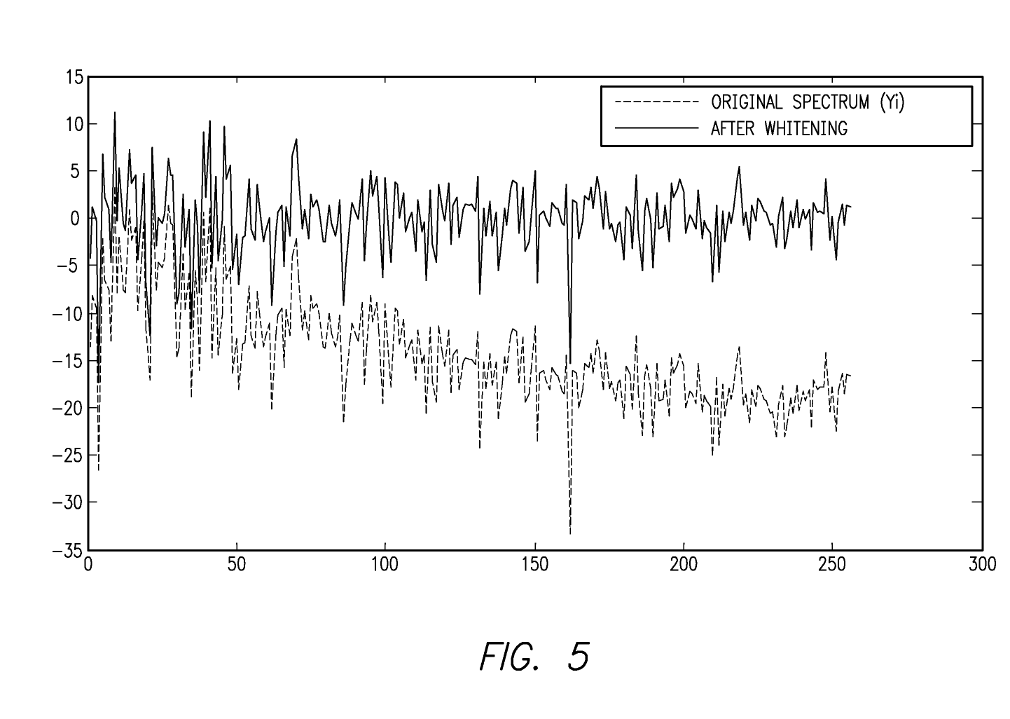

By performing an inverse DCT of Zᵢ^{f}, the detection method is able to obtain a whitened signal Yᵢ (identified as Yᵢ^{w}) at the output of block (403). In an embodiment of the present disclosure, the top number of coefficients to be retained can be 18. FIG. 5 shows a result of a whitening step using cepstral filtering where the top 18 cepstral coefficients are retained out of 256 coefficients.

It should be noted that other types of filtering, besides cepstral filtering described above, could be used to obtain a whitened spectrum. For example, a high-pass filter or a moving average whitening filter could be used as well. A moving average whitening filter computes the mean value around a window of the current sample and subtracts the computed mean from that sample. The window is moved to the next sample and the process is repeated again.

Turning now to FIG. 4, a feature is computed (404) that corresponds to averages of the whitened spectrum (Yᵢ^{w}) over a number of frames that is equal to the repetition_actor as shown below:

Yᵢ^{aw}=(1/repetition_factor)ΣYⱼ^{w}, where j=i, i+1, . . . , (i+repetition-factor−1),

where signal Yᵢ^{aw} represents the output of block (404).

Reference will now be made to steps/blocks (405)-(407), which show an AdaBoost-based method in accordance with the embodiment of FIG. 4. In other words, detection scores are calculated from a set of competing statistical learning models, and a detection decision as to which data is embedded in the audio signal is performed by comparing the calculated detection scores.

The notation used in the following paragraphs is similar to the notation used in Y. Freund, R. Schapire, A Short Introduction to Boosting, Journal of Japanese Society for Artificial Intelligence, 14(5): 771-780, September 1999, which is incorporated herein on reference in its entirety. In particular, the AdaBoost algorithm calls a given “weak or base learning algorithm” repeatedly in a series of rounds t=1, 2, . . . T. One of the main concepts behind the algorithm is to maintain a distribution or set of weights. Initially, all weights are set equally but on each round, the weights of incorrectly classified examples are increased. In particular, adopting a notation similar to that used in FIG. 1 of the above mentioned paper, the detecting method scores can be computed as follows:

H₀(Yᵢ^{aw})=sign(Σα_{t,0}h_{t,0}(Yᵢ^{aw}))

H₁(Yᵢ^{aw})=sign(Σα_{t,1}h_{t,1}(Yᵢ^{aw}))

where t=1, 2, . . . T, and where H₀(Yᵢ^{aw}) (405) is a model score for detecting a zero bit, while H₁(Yᵢ^{aw}) (406) is a model score for detecting a one bit. Comparison of the two model scores (for detecting a zero bit and a one bit) is then performed (407). If H₀(Yᵢ^{aw})>H₁(Yᵢ^{aw}), then a detected bit is zero. Otherwise, if H₀(Yᵢ^{aw})<H₁(Yᵢ^{aw}), then the detected bit is one.

The parameters of the model score for zero are α_{t,0}, h_{t,0}(Yᵢ^{aw}) and T. In the embodiment of FIG. 4, h_{t,0} (Yᵢ^{aw}) represents a weak classifier that detects a zero bit with a probability of accurate detection which is slightly better than random (>0.5). α_{t,0} is a weight associated with the t^{th} weak classifier of h_{t,0}(Yᵢ^{aw}). T is a total number of weak classifiers whose decisions are combined to derive a score for a final strong model for zero bit (classifier). Similarly, α_{t,1}, h_{t,1} (Yᵢ^{aw}) and T represent model parameters for the model score to detect a one bit.

In an embodiment of the present disclosure, model parameters can be determined through an off-line training procedure. For example, given a set of labeled training data (e.g. embedding frames where a 0 bit was embedded or frames without any embedding), the off-line training procedure combines decisions of a set of weak classifiers to arrive at a stronger classifier. A weak classifier (e.g. decision stump) may not have high classification accuracy (e.g. >0.9), but the weak classifier's classification accuracy can be at least >0.5.

For example, a feature vector Yᵢ^{aw} can compare one element (energy in a particular frequency coefficient or “bin”) to a threshold and predict whether a zero was embedded or not. Then, by using the off-line training procedure, the weak classifiers can be combined to obtain a strong classifier with a high accuracy. While learning a final strong classifier, the off-line training procedure also determines a relative significance of each of the weak classifiers through weights (α_{t,1}, α_{t,0}). So, if the weak classifiers are decisions stumps based on energy in each frequency bin in a whitened averaged spectrum (Yᵢ^{aw}), then a learned off-line training model also determine which frequency components are more significant than others.

An off-line training framework can be formulated as follows. Given a set of training data with features (such as whitened averaged spectral vectors) derived from frames consisting of different types of training examples; for example two different types where a zero or one bit was embedded and examples where there was no data bit embedded.

For an embodiment of the present disclosure, a feature vector can be represented for frame “i” as Yᵢ^{aw}, (with a L dimensional feature vector where i=1, 2, . . . M). Also a label Xᵢ can be used in each example indicating whether a zero or one bit was embedded or if no bit was embedded. For example, Xᵢ=+1 can be used when a zero or one was embedded while Xᵢ=−1 can be used if no bit was embedded.

Furthermore, a number of weak classifiers can be identified as h_{t,0} (t=1, 2, . . . T). Each h_{t,0} maps an input feature vector (Yᵢ^{aw}) to a label (Xᵢ). Also a predicted label X_{i,t,0} by the weak classifier (h_{t,0}) matches a correct ground truth label Xᵢ at least more than 50% of an M number of training instances.

With a given training data, a learning algorithm selects a number of weak classifiers and learns a set of weights α_{t,0} corresponding to each of the weak classifiers. A strong classifier, H₀(Yᵢ^{aw}) can be expressed as in the equation below:

H₀(Yᵢ^{aw})=sign(Σα_{t,0}h_{t,0}(Yᵢ^{aw}))

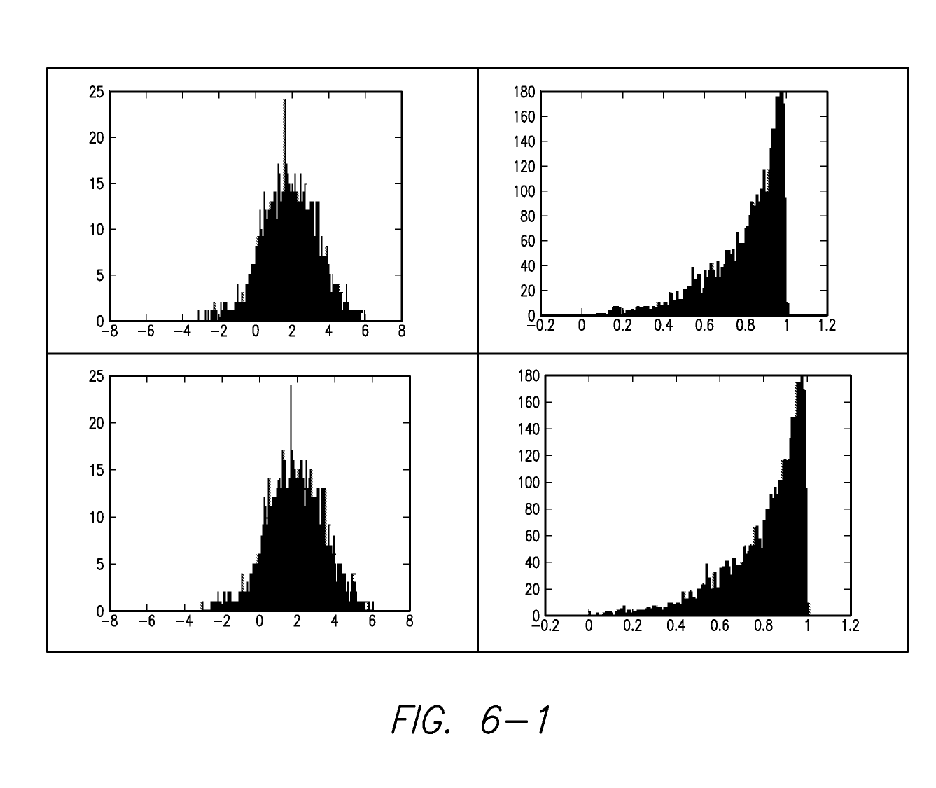

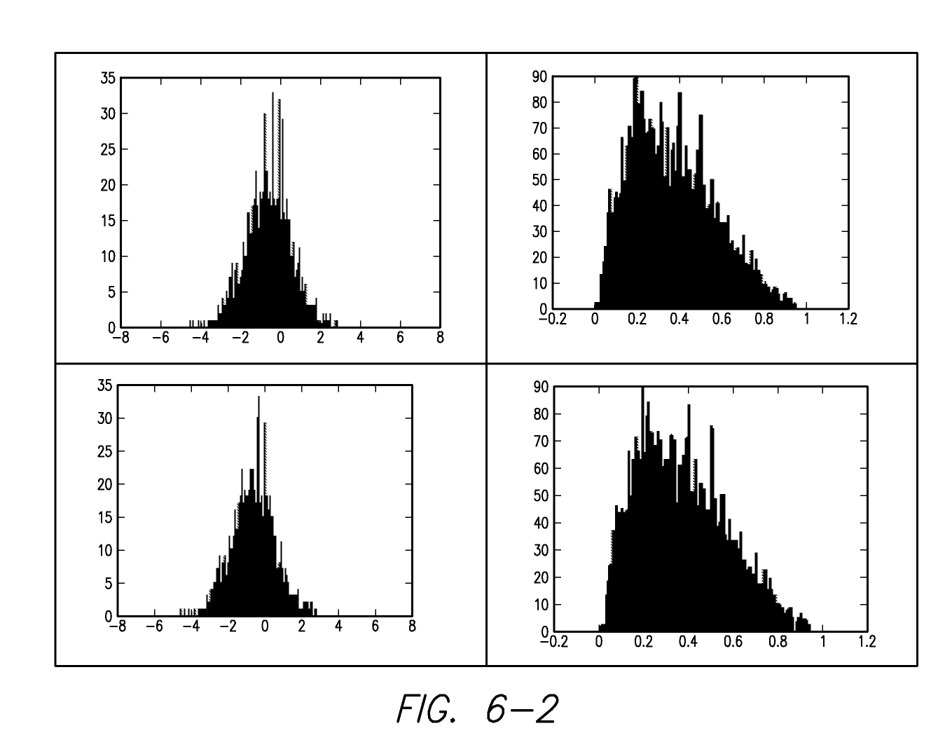

FIGS. 6-1 and 6-2 show a probability distribution of detection statistic when embedding and when there is no data embedded.

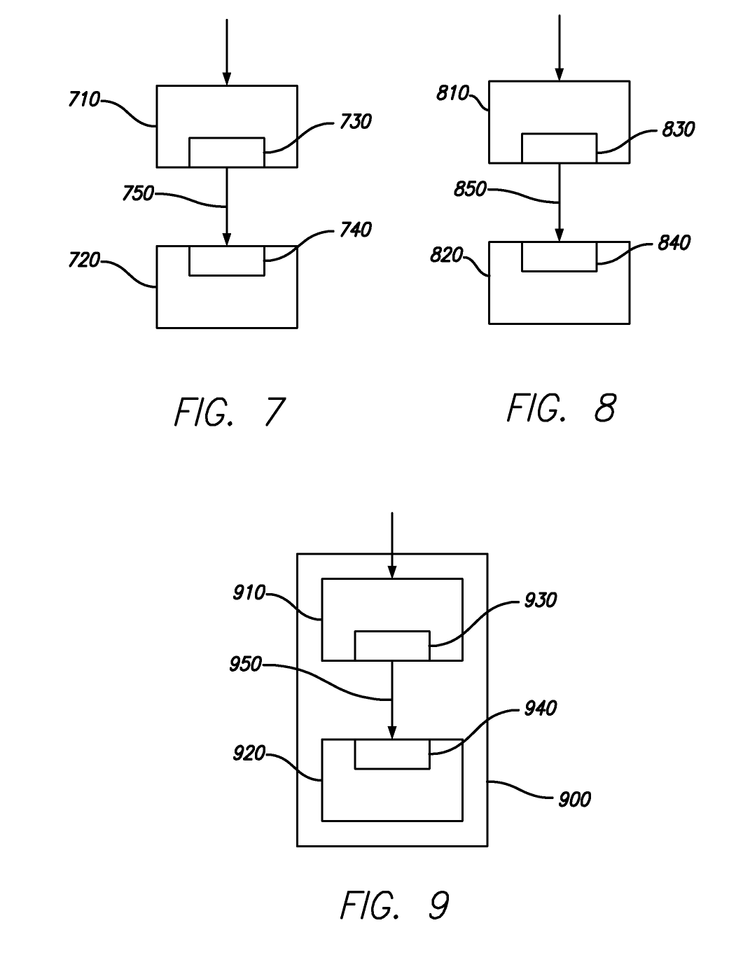

The embodiments discussed so far in the present application address the structure and function of the embedding and detection systems and methods of the present disclosure as such. The person skilled in the art will understand that such systems and methods can be employed in several arrangements and/or structures. By way of example and not of limitation. FIGS. 7-9 show some examples of such arrangements.

In particular, FIGS. 7 and 8 show conveyance of audio data with embedded watermark as metadata hidden in the audio between two different devices on the receiver side, such as a set top box (710) and an audio video receiver or AVR (720) in FIG. 7, or a first AVR (810) and a second AVR (820) in FIG. 8. In FIG. 7, the set top box (710) contains an audio watermark embedder (730) like the one described in FIG. 1, while the AVR (720) contains an audio watermark detector (740) like the one described in FIG. 5. Similarly, in FIG. 8, the first AVR (810) contains an audio watermark embedder (830), while the second AVR (820) contains an audio watermark detector (840). Therefore, processing in the second AVR (820) can be adapted according to the extracted metadata from the audio signal. Furthermore, unauthorized use of the audio signal (750) between the devices in FIG. 7 or the audio signal (850) between the devices in FIG. 8 will be recognized in view of the presence of the embedded watermark.

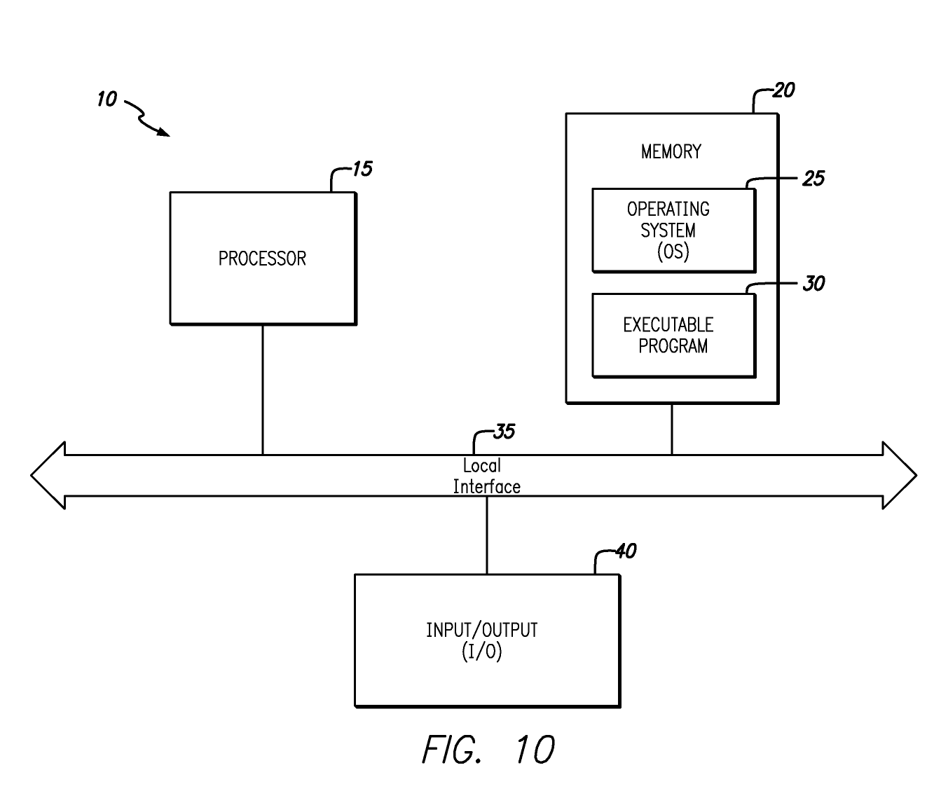

Similarly, FIG. 9 shows conveyance of audio data with embedded watermark metadata between different processes in the same operating system (such as Windows®, Android®, iOS® etc) of a same product (900). An audio watermark is embedded (930) in an audio decoder process (910) and then detected (940) in an audio post processing process (920). Therefore, the post processing process can be adapted according to the extracted metadata from the audio signal

The audio data spread spectrum embedding and detection system in accordance with the present disclosure can be implemented in software, firmware, hardware, or a combination thereof. When all or portions of the system are implemented in software, for example as an executable program, the software may be executed by a general purpose computer (such as, for example, a personal computer that is used to run a variety of applications), or the software may be executed by a computer system that is used specifically to implement the audio data spread spectrum embedding and detection system.

FIG. 10 shows a computer system (10) that may be used to implement the audio data spread spectrum embedding and detection system of the present disclosure. It should be understood that certain elements may be additionally incorporated into computer system (10) and that the figure only shows certain basic elements (illustrated in the form of functional blocks). These functional blocks include a processor (15), memory (20), and one or more input and/or output (I/O) devices (40) (or peripherals) that are communicatively coupled via a local interface (35). The local interface (35) can be, for example, metal tracks on a printed circuit board, or any other forms of wired, wireless, and/or optical connection media. Furthermore, the local interface (35) is a symbolic representation of several elements such as controllers, buffers (caches), drivers, repeaters, and receivers that are generally directed at providing address, control, and/or data connections between multiple elements.

The processor (15) is a hardware device for executing software, more particularly, software stored in memory (20). The processor (15) can be any commercially available processor or a custom-built device. Examples of suitable commercially available microprocessors include processors manufactured by companies such as Intel®, AMD®, and Motorola®.

The memory (20) can include any type of one or more volatile memory elements (e.g., random access memory (RAM, such as DRAM, SRAM, SDRAM, etc.)) and nonvolatile memory elements (e.g., ROM, hard drive, tape, CDROM, etc.). The memory elements may incorporate electronic, magnetic, optical, and/or other types of storage technology. It must be understood that the memory (20) can be implemented as a single device or as a number of devices arranged in a distributed structure, wherein various memory components are situated remote from one another, but each accessible, directly or indirectly, by the processor (15).

The software in memory (20) may include one or more separate programs, each of which comprises an ordered listing of executable instructions for implementing logical functions. In the example of FIG. 10, the software in the memory (20) includes an executable program (30) that can be executed to implement the audio data spread spectrum embedding and detection system in accordance with the present invention. Memory (20) further includes a suitable operating system (OS) (25). The OS (25) can be an operating system that is used in various types of commercially-available devices such as, for example, a personal computer running a Windows® OS, an Apple® product running an Apple®-related OS, or an Android® OS running in a smart phone. The operating system (22) essentially controls the execution of executable program (30) and also the execution of other computer programs, such as those providing scheduling, input-output control, file and data management, memory management, and communication control and related services.

Executable program (30) is a source program, executable program (object code), script, or any other entity comprising a set of instructions to be executed in order to perform a functionality. When a source program, then the program may be translated via a compiler, assembler, interpreter, or the like, and may or may not also be included within the memory (20), so as to operate properly in connection with the OS (25).

The I/O devices (40) may include input devices, for example but not limited to, a keyboard, mouse, scanner, microphone, etc. Furthermore, the I/O devices (40) may also include output devices, for example but not limited to, a printer and/or a display. Finally, the I/O devices (40) may further include devices that communicate both inputs and outputs, for instance but not limited to, a modulator/demodulator (modem; for accessing another device, system, or network), a radio frequency (RF) or other transceiver, a telephonic interface, a bridge, a router, etc.

If the computer system (10) is a PC, workstation, or the like, the software in the memory (20) may further include a basic input output system (BIOS) (omitted for simplicity). The BIOS is a set of essential software routines that initialize and test hardware at startup, start the OS (25), and support the transfer of data among the hardware devices. The BIOS is stored in ROM so that the BIOS can be executed when the computer system (10) is activated.

When the computer system (10) is in operation, the processor (15) is configured to execute software stored within the memory (20), to communicate data to and from the memory (20), and to generally control operations of the computer system (10) pursuant to the software. The audio data spread spectrum embedding and detection system and the OS (25), in whole or in part, but typically the latter, are read by the processor (15), perhaps buffered within the processor (15), and then executed.

When the audio data spread spectrum embedding and detection system is implemented in software, as is shown in FIG. 10, it should be noted that the audio data spread spectrum embedding and detection system can be stored on any computer readable storage medium for use by, or in connection with, any computer related system or method. In the context of this document, a computer readable storage medium is an electronic, magnetic, optical, or other physical device or means that can contain or store a computer program for use by, or in connection with, a computer related system or method.

The audio data spread spectrum embedding and detection system can be embodied in any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any non-transitory tangible means that can store, communicate, propagate, or transport the program for use by or in connection with the instruction execution system, apparatus, or device. The computer readable storage medium can be, for example but not limited to, an electronic, magnetic, optical, electromagnetic, infrared, or semiconductor system, apparatus, or device. More specific examples (a non-exhaustive list) of the computer-readable storage medium would include the following: a portable computer diskette, a random access memory (RAM), a read-only memory (ROM), an erasable programmable read-only memory (EPROM, EEPROM, or Flash memory) an optical disk such as a DVD or a CD.

In an alternative embodiment, where the audio data spread spectrum embedding and detection system is implemented in hardware, the audio data spread spectrum embedding and detection system can implemented with any one, or a combination, of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The examples set forth above are provided to give those of ordinary skill in the art a complete disclosure and description of how to make and use the embodiments of the audio data spread spectrum embedding and detection of the disclosure, and are not intended to limit the scope of what the inventor regards as his disclosure. Modifications of the above-described modes for carrying out the disclosure can be used by persons of skill in the art, and are intended to be within the scope of the following claims.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only, and is not intended to be limiting. As used in this specification and the appended claims, the singular forms “a”, “an”, and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the disclosure have been described. Nevertheless, it will be understood that various modifications can be made without departing from the spirit and scope of the present disclosure. Accordingly, other embodiments are within the scope of the following claims.

1. A method to embed data in an audio signal, comprising:
selecting a pseudo-random sequence according to desired data to be embedded in the audio signal;
shaping a frequency spectrum of the pseudo-random sequence with a frequency spectrum of the audio signal, thus forming a shaped frequency spectrum of the pseudo-random noise sequence; and
subtracting the shaped frequency spectrum of the pseudo-random sequence from the frequency spectrum of the audio signal spectrum.

2. The method according to claim 1, wherein the selected pseudo-random sequence is a function of pseudo-random chip sequences of {+1, −1}.

3. The method according to claim 1, wherein the shaping and subtracting steps occur on an audio frame by audio frame basis.

4. The method according to claim 1, wherein the frequency spectrum of the pseudo-random sequence comprises of frequency coefficients different from zero only in a desired frequency range.

5. The method according to claim 4, wherein the desired frequency range is between 2 kHz to 7.5 kHz.

6. The method according to claim 3, wherein the selecting, shaping and subtracting steps for a specific data are repeated for a set number of audio frames.

7. The method according to claim 6, wherein the set number of audio frames is three audio frames.

8. A computer-readable storage medium having stored thereon computer-executable instructions executable by a processor to detect embedded data in an audio signal, the detecting comprising:
calculating detection scores from a set of competing statistical learning models, wherein the detection scores are based on the audio signal; and
performing a detection decision as to which data is embedded in the audio signal by comparing with each other the calculated detection scores.

9. The method according to claim 8, wherein the competing statistical learning models are a statistical learning model for detecting a zero bit and a statistical learning model for detecting a one bit.

10. The method according to claim 8, wherein the competing statistical learning models are Adaboost models.

11. The method according to claim 8, wherein calculating the detection scores comprises obtaining a feature vector from the audio signal.

12. The method according to claim 11, wherein the feature vector is a whitened spectrum of the audio signal.

13. The method according to claim 8, wherein parameters of the statistical learning models are obtained from a computer-based offline training step.

14. The method of claim 13, wherein the offline training step further comprises at least the following two sets of audio data:
a first set of audio data with a same embedded data bit; and
a second set of audio data without any embedded data bit.

15. The method according to claim 14, wherein the off-line training step extracts features from the two sets of audio data and learns the parameters of the statistical learning models.

16. An audio signal receiving arrangement comprising a first device and a second device, the first device comprising an audio watermark embedder to embed a watermark in the audio signal, the second device comprising an audio watermark detector to detect the watermark embedded in the audio signal and adapt processing on the second device according to the extracted watermark data, the audio watermark embedder being operative to embed the watermark in the audio signal according to the method of claim 1, the audio watermark detector being operative to detect the watermark embedded in the audio signal according to the method of claim 8.

17. The audio signal receiving arrangement of claim 16, wherein the first device is a set top box, and the second device is an audio video receiver separate from the set top box.

18. The audio signal receiving arrangement of claim 16, wherein the first device is a first audio video receiver, and the second device is a second audio video receiver separate from the first audio video receiver.

19. An audio signal receiving product comprising a computer system having an executable program executable to implement a first process and a second process, the first process embedding a watermark in the audio signal, the second process detecting the watermark embedded in the audio signal, the second process being adapted according to the detected watermark data, the first process operating according to the method of claim 1, the second process operating according to the method of claim 8.

20. A system to embed data in an audio signal, the system comprising:
a processor configured to:
select a pseudo-random sequence according to desired data to be embedded in the audio signal;
shape a frequency spectrum of the pseudo-random sequence with a frequency spectrum of the audio signal, thus forming a shaped frequency spectrum of the pseudo-random sequence; and
subtract the shaped frequency spectrum of the pseudo-random noise sequence from the frequency spectrum of the audio signal spectrum.

21. The system according to claim 20, wherein the selected pseudo-random sequence is a function of pseudo-random chip sequences of {+1, −1}.

22. The system according to claim 21, further comprising:
a memory for storing computer-executable instructions accessible by said processor for embedding the data in the audio signal; and
an input/output device configured to, at least, receive the audio signal and provide the audio signal to the processor.

23. A system to detect embedded data in an audio signal, the system comprising:
a processor configured to:
calculating detection scores from a set of competing statistical learning models, wherein the detection scores are based on the audio signal; and
performing a detection decision as to which data is embedded in the audio signal by comparing a first model score for detecting a zero bit with a second model score for detecting a one bit.
